(19) United States
(12) Patent Application Publication
(10) Pub. No.: US 2011/0262006 A1
(43) Pub. Date: Oct. 27, 2011

(54) INTERFACE APPARATUS, GESTURE RECOGNITION METHOD, AND GESTURE RECOGNITION PROGRAM

(75) Inventor: Masataka NAKANO, Kanagawa (JP)

(73) Assignee: RENESAS ELECTRONICS CORPORATION, Kanagawa (JP)

(21) Appl. No.: 13/086,789

(22) Filed: Apr. 14, 2011

(30) Foreign Application Priority Data
Apr. 26, 2010 (JP) 2010-101485

(51) Int. Cl. G06K 9/00

(52) U.S. Cl. 382/103

(57) ABSTRACT

An interface apparatus is configured to output an operation signal to a target apparatus operated in accordance with a gesture command. In the interface apparatus, a reference object detection unit detects a reference object having a feature similar to a predetermined reference feature value from an image captured by an image capture unit and generates reference information identifying the reference object. Based on the reference information, an operating object identifying unit identifies as the operating object a feature object included in the image and satisfying a predetermined identification condition in terms of a relative relationship with the reference object and extracts operating object information identifying the operating object. An operation signal generation unit starts detecting the gesture command according to a change in position of the identified operating object and generates the operation signal corresponding to the gesture command.

### CROSS-REFERENCE TO RELATED APPLICATIONS

The disclosure of Japanese Patent Application No. 2010-101485 filed on Apr. 26, 2010 including the specification, drawings and abstract is incorporated herein by reference in its entirety.

### BACKGROUND

The present invention relates to an interface apparatus, a gesture recognition method, and a gesture recognition program, and more particularly, to an interface apparatus, a gesture recognition method, and a gesture recognition program configured to generate an operation signal to give a command to a target apparatus operated in accordance with a motion of a person.

In recent years, an interface apparatus has been developed that allows an operator to easily operate a device without needing an input apparatus such as a keyboard, a mouse, or the like. For example, Japanese Unexamined Patent Publication No. Hei 8 (1996)-044490 discloses an interface apparatus including an image pickup unit, a motion recognition unit configured to recognize a shape and a motion of an object in an image taken by the image pickup unit, and a display unit configured to display the shape and the motion recognized by the motion recognition unit. More specifically, in the interface apparatus disclosed in Japanese Unexamined Patent Publication No. Hei 8 (1996)-044490, a hand of an operator is recognized and an operation is recognized from the motion of the hand. In this interface apparatus disclosed in Japanese Unexamined Patent Publication No. Hei 8 (1996)-044490, a virtual switch or the like displayed on a display screen is selected according to a hand gesture made by the operator.

### SUMMARY

In the interface apparatus disclosed in Japanese Unexamined Patent Publication No. Hei 8 (1996)-044490, to obtain information identifying an operator, it is necessary to recognize a particular object from a captured image. For this purpose, in the interface apparatus disclosed in Japanese Unexamined Patent Publication No. Hei 8 (1996)-044490, a hand of the operator is recognized as the object. To identify the operator in the above-described manner, a high computation capacity is required to recognize the operator and the gesture made by the operator.

More specifically, the hand varies in shape and/or color depending on the operator. Besides, the hand has a different shape depending on a direction from which the image of the hand is taken. Therefore, to detect the hand from the captured image based on the shape of the hand, highly complicated information processing is necessary. In a case where the image includes two or more persons that can be candidates for the operator, it may be difficult to identify the true operator from the two or more candidates. Besides, the operator may made many motions in addition to a gesture made to issue an operation command. Therefore it is necessary to always monitor the motion of the operator to detect a start of a command gesture, and thus a high computation capacity is required to perform the monitoring. The technique disclosed in Japanese Unexamined Patent Publication No. Hei 8 (1996)-044490 has a problem that the above-described situation cannot be avoided.

According to an aspect of the present invention, an interface apparatus is configured to output an operation signal to a target apparatus operated in accordance with a gesture command, and the interface apparatus includes a reference object detection unit configured to detect a reference object having a feature similar to a predetermined reference feature value from an image taken by an image pickup unit and generate reference information identifying the reference object, an operating object identifying unit configured to, based on the reference information, identify as the operating object a feature object included in the image and satisfying a predetermined identification condition in terms of a relative relationship with the reference object and extract operating object information identifying the operating object, and an operation signal generation unit configured to start detecting the gesture command according to a change in position of the identified operating object and generate the operation signal corresponding to the gesture command.

According to another aspect of the present invention, a gesture recognition method in an interface apparatus is configured to output an operation signal to a target apparatus operated in accordance with a gesture command, and the gesture recognition method includes detecting a reference object having a feature similar to a predetermined reference feature value from an image taken by an image pickup unit and generating reference information identifying the reference object, based on the image and the reference information, identifying a feature object satisfying a predetermined identification condition in terms of a relative relationship with the reference object as an operating object, extracting operating object information identifying the operating object, starting detecting the gesture command based on a change in position of the identified operating object, and generating the operation signal according to the gesture command.

According to still another aspect of the present invention, there is provided a computer readable medium storing a gesture recognition program executable by an operation circuit configured to generate an operation signal to give an operation command to a target apparatus operated in accordance with a gesture command recognized based on an image taken by an image pickup unit. The gesture recognition program causes the operation circuit to execute a process which includes detecting a reference object having a feature similar to a predetermined reference feature value from the image taken by the image pickup unit and generating reference information identifying the reference object, based on the image and the reference information, identifying a feature object satisfying a predetermined identification condition in terms of a relative relationship with the reference object as an operating object, extracting operating object information identifying the operating object, and detecting the gesture command based on a change in position of the identified operating object, the program causing the operation circuit to output the operation signal according to the gesture command.

In the interface apparatus, the gesture recognition method, and the gesture recognition program according to the above aspects of the present invention, one feature object is detected as an operating object based on the reference object having a particular feature that has been defined in advance. Based on the detected operating object, the gesture command is detected. That is, in the interface apparatus and the gesture recognition method according to the present invention, an object, which satisfies the identification condition in terms of the relative relationship with the reference object that is easy to recognize, is determined as an operating object. Thus, in the interface apparatus and the gesture recognition method according to the present invention, it is possible to recognize the operator and the operating object via a simple computing process.

Thus, in the interface apparatus, the gesture recognition method, and the gesture recognition program according to the present invention, the gesture can be recognized via a simple process.

### BRIEF DESCRIPTION OF THE DRAWINGS

FIG. 1 is a block diagram illustrating a gesture control system according to a first embodiment of the present invention;

FIG. 2 is a block diagram illustrating an interface apparatus according to the first embodiment of the present invention;

FIG. 3 is a flow chart illustrating an operation of the interface apparatus according to the first embodiment of the present invention;

FIG. 4 is a flow chart illustrating an operation of an interface apparatus according to a second embodiment of the present invention; and

FIG. 5 is a block diagram of an interface apparatus according to a third embodiment of the present invention.

### DETAILED DESCRIPTION

### First Embodiment

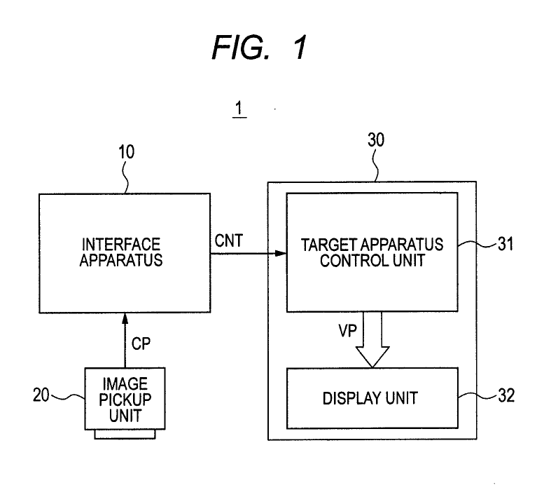

Embodiments of the present invention are described below with reference to the accompanying drawings. FIG. 1 is a block diagram illustrating a gesture control system 1 including an interface apparatus according to a first embodiment. In the example shown in FIG. 1, a television set is controlled in accordance with a gesture command. Note that the gesture command refers to a command given by a motion of a person to control a target apparatus to be controlled (hereinafter referred to simply as a target apparatus). The target apparatus is not limited to a television set, but many other apparatuses such as a video playback apparatus, a personal computer (PC), an audio device, and an air conditioner may be controlled according to the present embodiment. As shown in FIG. 1, the gesture control system 1 includes an interface apparatus 10, an image pickup unit 20, and a target apparatus 30.

The image pickup unit 20 may be, for example, a camera configured to take an image in an area in which an operator operates the target apparatus 30. The image pickup unit 20 takes the image at predetermined intervals. The image obtained at each shooting timing is referred to as a frame.

The interface apparatus 10 captures images taken by the image pickup unit 20 on a frame-by-frame basis and recognizes a gesture command issued by an operator based on the captured images. The interface apparatus 10 then outputs an operation signal CNT based on the recognized gesture command.

The target apparatus 30 includes a target apparatus control unit 31 and a display unit 32. The target apparatus 30 generates a varying display control signal VP based on the operation signal CNT. The display unit 30 displays an image generated in accordance with the display control signal VP. Note that the image displayed on the display unit 32 is viewed by the operator.

In accordance with the motion of the operator, the gesture control system 1 changes the image displayed on the display unit 32. For example, in the gesture control system 1, an operation menu is displayed on the display unit 32, and the operation associated with the operation menu is controlled in accordance with the motion of the operator such that the operation menu is changed, an operation cursor is moved to point to an item in the operation menu, a television channel is changed, and a sound volume level is adjusted.

In the gesture control system 1 according to the first embodiment, the gesture recognition is performed by the interface apparatus 10 by a unique method as described in detail below. In the interface apparatus 10 according to the first embodiment, it is assumed by way of example that the gesture recognition function is realized by hardware. Note that the gesture recognition function may be realized by software (a gesture recognition program) on a general-purpose microcomputer.

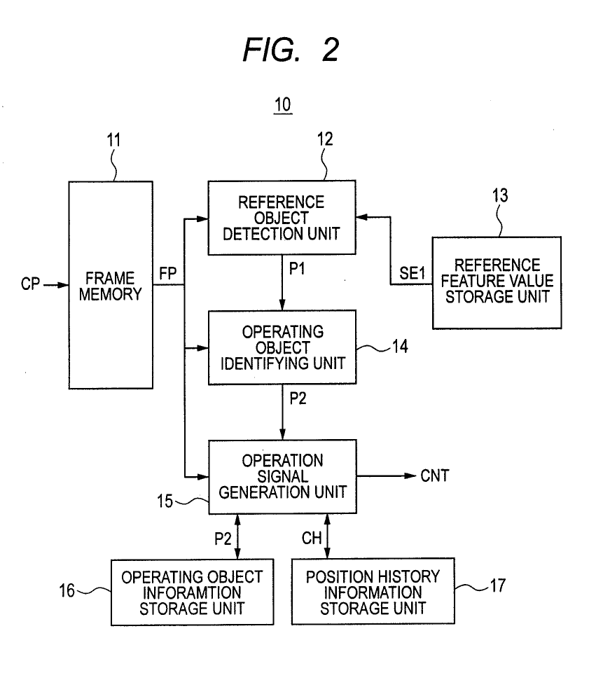

FIG. 2 is a block diagram of the interface apparatus 10. As shown in FIG. 2, the interface apparatus 10 includes a frame memory 11, a reference object detection unit 12, a reference feature value storage unit 13, an operating object identifying unit 14, an operation signal generation unit 15, an operating object information storage unit 16, and a position history information storage unit 17. Note that it does not necessarily need to provide a dedicated memory area for each of the frame memory 11, the reference feature value storage unit 13, the operating object information storage unit 16, and the position history information storage unit 17, but particular areas in a single memory may be used for these storage units. For example, in a case where the interface apparatus 10 is realized by a microcomputer, the storage units described above may be realized in a memory used by the microcomputer.

The frame memory 11 stores the captured images CP on a frame-by-frame basis. Note that the captured images CP stored in the frame memory 11 include a captured image CP of a current frame and a captured image CP of a previous frame.

The reference object detection unit 12 reads the image of the current frame as a reference image FP from the images stored in the frame memory 11. The reference object detection unit 12 analyzes the read image to detect a reference object having a feature similar to a predetermined reference feature value SE1, and the reference object detection unit 12 generates reference information P1 identifying the reference object. Note that the reference feature value SE1 is read from the reference feature value storage unit 13. In the interface apparatus 10 according to the first embodiment, it is assumed by way of example that a face of a person is used as the reference object. Thus, in the first embodiment, the reference feature value SE1 includes information associated with features that allow it to recognize the face of the person. Examples of features usable for the present purpose include a color, a shape, a distribution of density, etc. of a face of a person. Note that the reference object is not limited to a face of a person, but a fixed object in the image area may be employed as the reference object. Also note that it is assumed that the reference information P1 includes position information associated with the reference object.

Based on the reference image FP and the reference information P1, the operating object identifying unit 14 detects a feature object that satisfies a predetermined identification condition in terms of a relative relationship with the reference object and the operating object identifying unit 14 identifies the detected feature object as the operating object. The operating object identifying unit 14 then extracts operating object information P2 identifying the operating object. In the first embodiment, the identification condition is that an object should cover at least a part of the reference object specified by the reference information. That is, in the first embodiment, when the operating object identifying unit 14 finds an object candidate that covers at least a part of the reference object, the operating object identifying unit 14 identifies it as the operating object. More specifically, in this identifying process, when an object is located between the image pickup unit 20 and the reference object and it covers at least a part of the reference object as viewed from the image pickup unit 20, the object is identified as the operating object. When the identification is performed by simply regarding a feature object that covers at least a part of the reference object as an operating object, if there is a possibility that an object that is not the true operating object is identified wrongly as the operating object, a further required condition may be defined in addition to the basic identification condition associated with the operating object. More specifically, for example, when an object is detected that satisfies the basic identification condition, this object is regarded as a candidate for the operating object, and a further evaluation is made on this candidate to check whether it further satisfies a particular condition in terms of a change in position (for example, a movement of swinging right and left). If it satisfies this further condition, then it is identified as the operating object.

To perform the process described above, the operating object identifying unit 14 reads both the image of the current frame and the image of the previous frame as the reference images FP. The operating object identifying unit 14 then compares the reference object in the image of the current frame with the reference object in the image of the previous frame and recognizes an object covering a part of the reference object. The determination as to whether the object covers a part of the reference object may be made, for example, as follows. In a case where the reference object is a face, an object that has a circular shape and a flesh color is recognized as the reference object. Thus, if the face is partially covered with a hand, an object having a shape and a color of the hand covering the face is recognized as the operating object. The operating object identifying unit 14 then, from the reference image FP, extracts operating object information P2 identifying the object recognized as the operating object. In the example described above, the operating object information P2 includes information associated with the shape and the color of the part recognized as the operating object.

If the operating object is identified, the operation signal generation unit 15 starts detecting a gesture command issued to the target apparatus control unit 31 based on a change in position of the operating object, and the operation signal generation unit 15 outputs an operation signal CNT based on the detected gesture command to the target apparatus control unit 31. More specifically, if the operation signal generation unit 15 receives operating object information P2 from the operating object identifying unit 14, the operation signal generation unit 15 registers the operating object information P2 in the operating object information storage unit 16, and the operation signal generation unit 15 reads the image of the current frame as the reference image FP. Then, based on the operating object information P2, the operation signal generation unit 15 extracts position information associated with the operating object from the reference image FP and generates position history information CH. Furthermore, the operation signal generation unit 15 generates an operation signal CNT based on the position history information CH. More specifically, the operation signal generation unit 15 extracts position change information associated with the operating object based from the difference between the position information associated with the operating object in the current frame in the reference image FP and the position history information CH stored in the position history information storage unit 17, and the operation signal generation unit 15 outputs the resultant position change information as the operation signal CNT to the target apparatus control unit 31. The operation signal generation unit 15 updates the position history information CH based on the position information associated with the operating object extracted from the reference image FP after the operation signal CNT is generated. Note that the position history information CH may be stored in time series so as to indicate a change in position of the operating object with time, or only the position information associated with the immediately previous frame may be stored.

The operation signal generation unit 15 tracks the operating object based on the operating object information P2. In the tracking, if a predetermined cancelation condition is satisfied, the registration of the operating object is cancelled. Examples of cancelation conditions are no detection of a feature corresponding to an operating object over a period longer than a timeout period, no detection of a change in potion of an operating object over a period longer than a timeout period, and a detection of a particular motion (such as a motion of a hand along a cross in a predetermined period) made by an operating object. The cancelling of the registration of the operating object by the operation signal generation unit 15 may be performed, for example, by clearing the operating object information P2 stored in the operating object information storage unit 16. Note that the operation signal generation unit 15 includes a counter (not show) to measure a time during which no operating object is detected and also includes a storage unit for storing a value specifying the timeout period.

As described above, the interface apparatus 10 generates the operation signal CNT based on a change in position of the operating object, and the target apparatus control unit 31 changes the display control signal VP in accordance with the operation signal CNT. For example, the target apparatus control unit 31 performs an operation such as moving of an operation cursor in accordance with the operation signal CNT such as position change vector information associated with the operating object. Furthermore, the target apparatus control unit 31 may generate a movement locus of the operating object from the history information of the operation signal CNT and may switch a television selection channel based on the information about the movement locus.

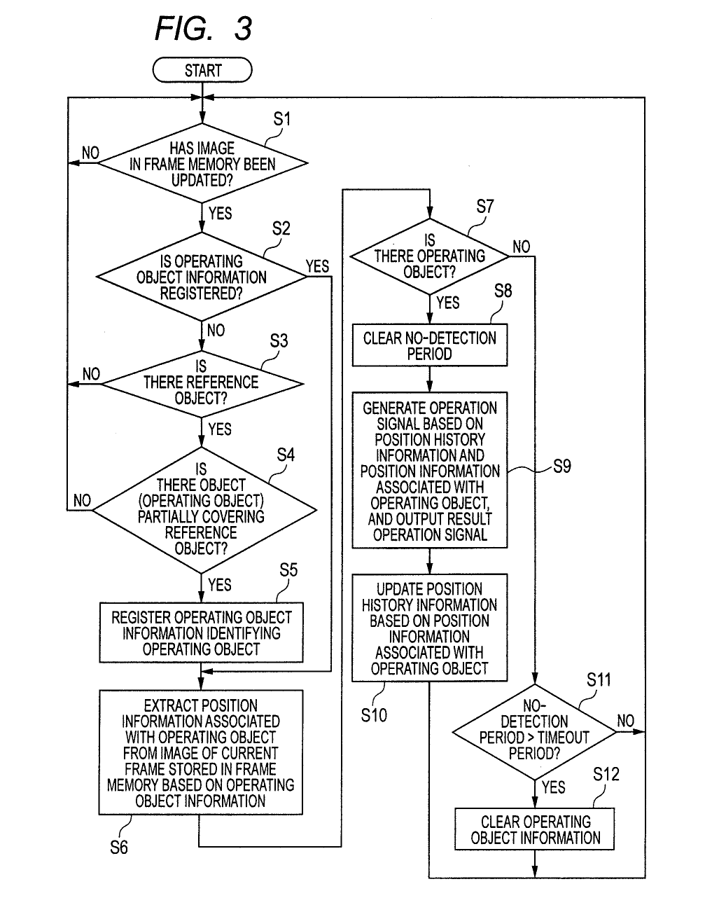

The operation of the interface apparatus 10 is described in further detail below. FIG. 3 is a flow chart illustrating the operation of the interface apparatus 10. Note that in the example shown in FIG. 3, only the condition that the operating object covers a part of the reference object is used as the identification condition, and only the condition that the operating object does not change in its position over a period longer than the timeout period is used as the cancelation condition. However, the identification condition and the cancelation condition are not limited to those described above, but other conditions may be employed.

As shown in FIG. 3, in the operation of the interface apparatus 10, in a first step S1 immediately after the operation is started, a determination is made as to whether the image stored in the frame memory 11 has been updated (i.e., whether the image of the newest frame has been updated). The process in step S1 is performed, for example, by the reference object detection unit 12. The process in step S1 is repeated until it is determined that the image has been updated (i.e., step S1 is repeated as long as the answer to step S1 is NO). If it is determined in step S1 that the image has been updated (i.e., if the answer to step S1 is YES), the processing flow proceeds to step S2.

In step S2, a determination is made as to whether an operating object has been identified via a previous process and whether operating object information associated with that operating object has been registered. This process in step S2 is performed, for example, by the reference object detection unit 12 by referring to the operating object information storage unit 16. In a case where it is determined in step S2 that the operating object information associated with the operating object has not yet been registered (i.e., if the answer to step S2 is NO), the processing flow proceeds to step S3 and further to the following steps S4 and S5 to identify the reference object and the operating object. On the other hand, if it is determined in step S2 that the operating object information associated with the operating object has already been registered (i.e., if the answer to step S2 is YES), then the processing flow proceeds to step S6 and further to the following steps S6 to S12 to track the operating object.

In the process of identifying the operating object and the operating object, first, the reference object detection unit 12 generates reference information P1 identifying the reference object based on the reference image FP and the reference feature value SE1 (step S3). This process in step S3 is performed by the reference object detection unit 12. If no object is found as the reference object (for example, a face of a person) in the image in step S3 (i.e., if the answer to step S3 is NO), then the processing flow returns to step S1. On the other hand, in a case where an object serving as the reference object is found in step S3 (i.e., if the answer to step S3 is YES), then the processing flow proceeds to step S4.

In step S4, the operating object is identified and operating object information P2 identifying the operating object is generated. More specifically, in step S4, based on the reference image FP and the reference information P1, a feature object that satisfies a predetermined identification condition in terms of a relative relationship with the reference object is identified as the operating object, and operating object information identifying the operating object is extracted. In the first embodiment, an object that covers a part of the reference object is identified as the operating object, and thus, in this step S4, a determination is made as to whether there is an object satisfying such an identification condition. The process in step S4 is performed by the operating object identifying unit 14. In a case where it is determined in step S4 that there is no object identified as the operating object in the reference image FP (that is, if the answer to step S4 is NO), the processing flow returns to step S1. On the other hand, if it is determined in step S4 that there is an object identified as the operating object in the reference image FP (that is, if the answer to step S4 is YES), the processing flow proceeds to step S5.

In step S5, the operating object information P2 extracted in step S4 is registered in the operating object information storage unit 16. The process in step S5 is performed by the operation signal generation unit 15. The receiving of the operating object information P2 from the operating object identifying unit 14 serves as a trigger that makes the operation signal generation unit 15 start tracking the operating object (steps S6 to S12).

The process of tracking the operating object is performed by the operation signal generation unit 15. In the process of tracking the operating object, first, in step S6, the operating object information P2 that has been registered is referred to, and position information associated with the operating object is extracted from the reference image FP (the current frame of image). In the process of tracking the operating object, a determination is then made in step S7 as to whether there is an object serving as the operating object in the reference image FP. In a case where it is determined in step S7 that there is no object regarded as the operating object (i.e., if the answer to step S7 is NO), then the processing flow proceeds to step S11 in which a determination is made as to whether a no-detection period in which no operating object is detected has exceeded a timeout period. In a case where it is determined in step S11 that the no-detection period has exceeded the timeout period (i.e., if the answer to step S11 is YES), the processing flow proceeds to step S12. In step S12, the operating object identifying unit 14 clears the operating object information P2 stored in the operating object information storage unit 16. The processing flow then returns to step S1. On the other hand, in a case where it is determined in step S11 that the no-detection period has not yet exceeded the timeout period (i.e., if the answer to step S11 is NO), the processing flow returns to step S1.

In a case where it is determined in step S7 that there is an operating object (i.e., the answer to step S7 is YES), the processing flow proceeds to step S8 in which the operation signal generation unit 15 clears the no-detection period. Then in step S9, an operation signal CNT is generated based on the position history information CH stored in the position history information storage unit 17 and the position information extracted in step S6, and the resultant operation signal CNT is output. The processing flow then proceeds to step S10, in which the operation signal generation unit 15 updates the position history information CH based on the operating object information P2 extracted in step S6. The processing flow then returns to step S1.

Thus, in the first embodiment, as described above, the interface apparatus 10 detects an object that satisfies the identification condition in terms of a relative relationship with the reference object and recognizes it as the operating object. An example of an object specified as the reference object is such an object that has a less change in feature than the operating object has or such an object that has a stronger feature (or more features) than the operating object has. This makes it possible for the interface apparatus 10 to recognize the operating object via a less complicated process because the recognition of the operating object, which may require a complicated process in recognition, is performed based on the relative relationship with the reference object that is easy to recognize.

In the interface apparatus 10, as described above, an object that satisfies the identification condition in terms of the relative relationship with the reference object is recognized as the operating object. Therefore, in the interface apparatus 10, it is not necessary to always monitor the operating object, i.e., it is possible to reduce the process of tracking the operating object.

In the interface apparatus 10, the process of tracking the operating object by the operation signal generation unit 15 is not started until the operating object is identified. This means that, in the interface apparatus 10, the generation of the operation signal CNT in the tracking process is not performed unless a gesture is intentionally made by an operator. This makes it possible for the interface apparatus 10 to easily determine when a gesture command is started.

In the interface apparatus 10, as described above, the recognition of the operating object is performed by detecting an object having a particular relative relationship with the reference object. This makes it possible for the interface apparatus 10 to easily recognize the operating object even when the operating object has a great change in feature such as a shape, color, or the like as is the case with a hand. Furthermore, in the interface apparatus 10, because operating object information identifying the operating object is generated based on the recognized operating object, it is not necessary to define in advance the feature such as a shape of the operating object. That is, in the interface apparatus 10, there is no particular restriction on the object employed as the operating object, which allows a gesture command to be issued in a more flexible manner.

Furthermore, in the interface apparatus 10, because the operating object is identified based on the relative relationship with the reference object, it is not necessary to recognize each of different operators individually. This makes it possible to achieve a highly versatile system using the interface apparatus 10 because it is sufficient to simply define general features of an operator as reference feature values associated with the reference object.

Furthermore, in the interface apparatus 10, it is possible to identify the operating object without having to always monitor the operating object having a shape that changes in a complicated manner. This allows the interface apparatus 10 to minimize the period during which a complicated process is performed, which results in a reduction in power consumed in the gesture recognition process.

### Second Embodiment

In a second embodiment disclosed below, a method of identifying an operating object is different from that according to the first embodiment as described below. In the method of identifying the operating object according to the second embodiment, a positional relationship between the operating object and the reference object is employed as an identification condition for the identification of the operating object. That is, in the second embodiment, the operating object does not necessarily need to cover the reference object, but it is sufficient for the operating object to satisfy a particular positional relationship with the reference object.

More specifically, a feature object that can be a candidate for an operating object is identified as an operating object when the distance of the feature object from the reference object is within a predetermined range and the angle of a line extending from the feature object to the reference object with respect to a horizontal direction of the image area of pickup unit 20 is within a predetermined range. For example, in case where the reference object is a face of a person and the operating object is a hand of the person, when the person raises his/her hand, the face and the hand come to have a particular positional relationship. In this situation, if a feature object having such a positional relationship is detected, it can be identified as the operating object.

In the interface apparatus according to the second embodiment, a feature of an object expected to be used as an operating object is defined in advance as a feature of a feature object candidate. The predefined features of candidates for the operating object may include, for example, a color, a shape (simplified shape), a density distribution, and/or the like that are possible for the operating object. Furthermore, in the interface apparatus according to the second embodiment, identifying of an operating object may be performed as follows. That is, when a feature object candidate has a predetermined positional relationship with the reference object, if it satisfies a predetermined condition in terms of a change in position (such as a movement of swinging right and left) in a predetermined period, this feature object candidate can be identified as the operating object.

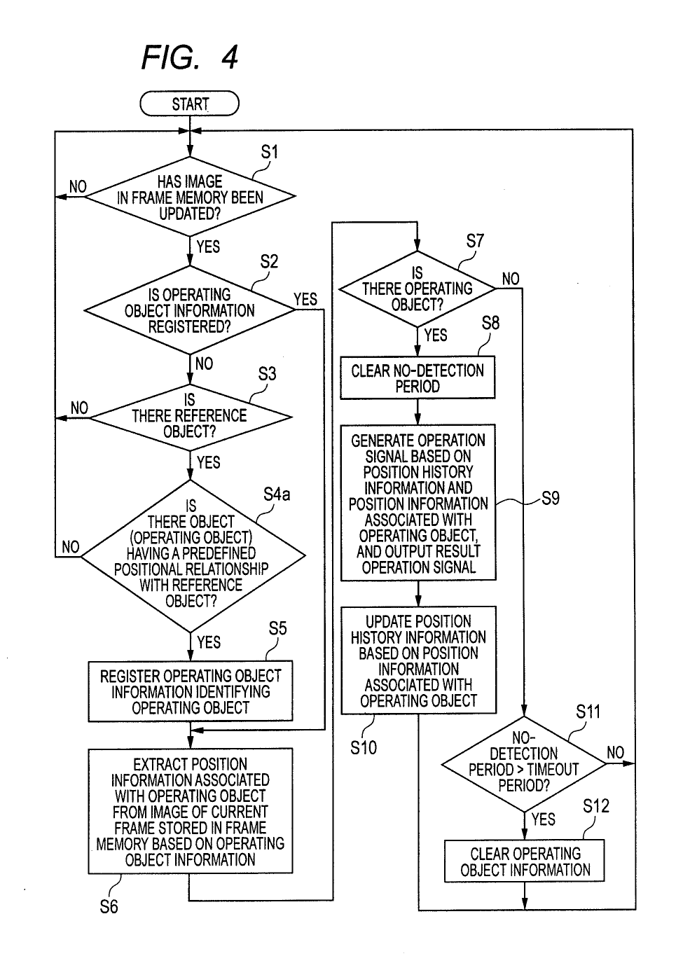

FIG. 4 is a flow chart illustrating an operation of the interface apparatus according to the second embodiment. As shown in FIG. 4, in the second embodiment, the operation of the interface apparatus is similar to that of the interface apparatus 10 according to the first embodiment except for a process in step S4a. In the operation of the interface apparatus according to the second embodiment, the process in step S4a is performed to identify an operating object based on the positional relationship between the operating object candidate and the reference object. In step S4a, if a feature object candidate having a particular positional relationship with the reference object is found, then the following movement of this feature object is monitored. If the feature object candidate makes a predetermined motion, then this feature object candidate is identified as the operating object.

In the method of identifying the operating object according to the embodiments of the invention, as described above, the operating object is identified based on the relative relationship between the reference object and a feature object that can be the operating object. The relative relationship may vary depending on the specifications of the system, the manner in which the system is used, or other factors.

### Third Embodiment

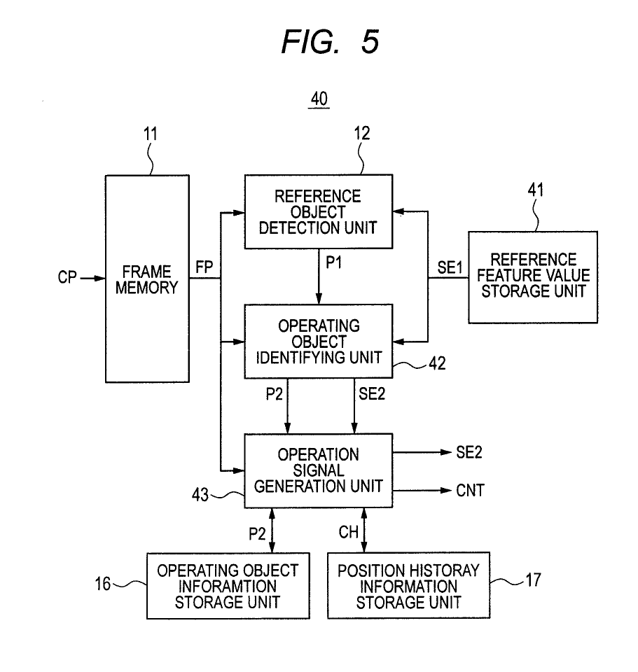

In a third embodiment described below, another example of a configuration for the interface apparatus is disclosed. FIG. 5 illustrates an interface apparatus 40 according to the third embodiment. The interface apparatus 40 is configured to output individual information (for example, a reference feature value SE2) of an operator together with an operation signal CNT.

For the above purpose, the interface apparatus 40 has a reference feature value storage unit 41 instead of the reference feature value storage unit 13, an operating object identifying unit 42 instead of the operating object identifying unit 14, and an operation signal generation unit 43 instead of the operation signal generation unit 15. The reference feature value storage unit 41 stores plural reference feature values SE1 associated with features corresponding to respective candidates who can be an operator. If the operating object identifying unit 42 identifies an operating object, then, from the reference feature value SE1, the operating object identifying unit 42 extracts a reference feature value SE2 associated with a reference object based on which the operating object has been identified. The operating object identifying unit 42 then outputs operating object information P2 together with the reference feature value SE2. The operation signal generation unit 43 outputs an operation signal CNT together with the reference feature value SE2 received from the operating object identifying unit 42.

The reference feature value SE2 of the reference object based on which the operating object is identified can be used to identify an operator. By inputting the reference feature value SE2 to the target apparatus control unit 31, it becomes possible for the target apparatus control unit 31 to perform different operations depending on the operators in accordance with the reference feature value SE2. For example, in a case where the operator is a child, the target apparatus control unit 31 may present an operation menu with a parental guard. On the other hand, in a case where the operator is an adult, the target apparatus control unit 31 may present an operation menu with no parental guard. In a case where the operator is an old person, the target apparatus control unit 31 may present an operation menu displayed in large characters.

As described above, the interface apparatus 40 according to the third embodiment is capable of identifying the operator, and the gesture control system using the interface apparatus 40 according to the third embodiment is capable of providing operations different for the respective operators. In the identifying of the operator in the above-described manner, the interface apparatus 40 is capable of identifying the operator via a simple process based on the relative relationship with the reference object.

The present invention is not limited to the embodiments described above, but many modifications are possible without departing from the spirit and the scope of the invention. For example, the interface apparatus and the target apparatus control unit in the target apparatus may be realized by a single microcomputer. The interface apparatus may be integrated with the target apparatus or may be formed separately from the target apparatus.

What is claimed is:

1. An interface apparatus configured to output an operation signal to a target apparatus operated in accordance with a gesture command, the interface apparatus comprising:
a reference object detection unit configured to detect a reference object having a feature similar to a predetermined reference feature value from an image taken by an image pickup unit and generate reference information identifying the reference object;
an operating object identifying unit configured to, based on the reference information, identify as the operating object a feature object included in the image and satisfying a predetermined identification condition in terms of a relative relationship with the reference object and extract operating object information identifying the operating object; and
an operation signal generation unit configured to start detecting the gesture command according to a change in position of the identified operating object and generate the operation signal corresponding to the gesture command.

2. The interface apparatus according to claim 1, wherein the operation signal generation unit registers the operating object information, extracts position information associated with the operating object from the image based on the operating object information, generates or updates position history information based on the extracted position information, and generates the operation signal based on the position history information.

3. The interface apparatus according to claim 1, wherein when the operating object satisfies a predetermined cancelation condition, the operation signal generation unit cancels the registration of the operating object.

4. The interface apparatus according to claim 1, wherein reference objects are a plurality of candidates who can be an operator,
wherein the reference feature values include a plurality of reference feature values associated with features of the respective candidates,
wherein the operating object identifying unit notifies the operation signal generation unit of the reference feature value of the reference object based on which the operating object is identified together with the operating object information associated with the operating object, and
wherein the operation signal generation unit outputs the reference feature value together with the reference feature value notified from the operation signal generation unit.

5. The interface apparatus according to claim 1, further comprising:
a frame memory configured to store the image on a frame-by-frame basis;
a position history information storage unit configured to store the position history information; and
an operating object information storage unit configured to store the operating object information,
wherein the reference object detection unit detects the reference object based on the image stored in the frame memory,
wherein the operating object identifying unit identifies the operating object and extracts the operating object information associated with the operating object based on a plurality of images at temporally different previous/following positions stored in the frame memory, and
wherein the operation signal generation unit updates the position history information based on the operating object information for each frame and generates the operation signal based on the position history information.

6. The interface apparatus according to claim 1, wherein the reference object detection unit and the operating object identifying unit respectively extract the reference information and the operating object information based on color information in the image.

7. The interface apparatus according to claim 1, wherein the operating object identifying unit identifies a feature object candidate that covers at least a part of the reference object as the operating object.

8. The interface apparatus according to claim 1, wherein the operating object identifying unit extracts at least one or more feature object candidates as candidates for the operating object from the image based on a predetermined candidate value associated with the operating object, and the operating object identifying unit identifies one of the feature object candidates as the operating object if the one of the feature object candidates satisfies the identification condition in terms of the positional relationship with the reference object.

9. The interface apparatus according to claim 7, wherein the operating object identifying unit ultimately identifies one of the feature object candidates as the operating object if the one of the feature object candidates satisfies a predetermined condition in terms of a change in position.

10. The interface apparatus according to claim 1, wherein the reference object is a face of a person and the operating object is a hand of the person.

11. The interface apparatus according to claim 1 provided in a target apparatus including the target apparatus control unit and a display unit configured to display a user interface image under the control of the target apparatus control unit.

12. A gesture recognition method in an interface apparatus configured to output an operation signal to a target apparatus operated in accordance with a gesture command, the method comprising:
detecting a reference object having a feature similar to a predetermined reference feature value from an image taken by an image pickup unit and generating reference information identifying the reference object;
based on the image and the reference information, identifying a feature object satisfying a predetermined identification condition in terms of a relative relationship with the reference object as an operating object;
extracting operating object information identifying the operating object;
starting detecting the gesture command based on a change in position of the identified operating object; and
generating the operation signal according to the gesture command.

13. A computer readable medium storing a gesture recognition program executable by an operation circuit configured to generate an operation signal to give an operation command to a target apparatus operated in accordance with a gesture command recognized based on an image taken by an image pickup unit, the program causing the operation circuit to execute a process comprising:
detecting a reference object having a feature similar to a predetermined reference feature value from the image captured by the image capture unit and generating reference information identifying the reference object;
based on the image and the reference information, identifying a feature object satisfying a predetermined identification condition in terms of a relative relationship with the reference object as an operating object;
extracting operating object information identifying the operating object; and
detecting the gesture command based on a change in position of the identified operating object,
the program causing the operation circuit to output the operation signal according to the gesture command.
